(19) United States
(12) Patent Application Publication
(10) Pub. No.: US 2016/0113257 A1
(43) Pub. Date: Apr. 28, 2016

(54) Rattling Swimbait Jig Head

(71) Applicant: Allen James Harrington, League City, TX (US)

(72) Inventor: Allen James Harrington, League City, TX (US)

(21) Appl. No.: 14/923,751

(22) Filed: Oct. 27, 2015

Related U.S. Application Data
(60) Provisional application No. 62/069,423, filed on Oct. 28, 2014.

(51) Int. Cl. A01K 85/01

(52) U.S. Cl. CPC A01K 85/01

(57) ABSTRACT

A rattling swimbait jig head includes a plastic rattle case, a stationary metal ball, a pair of mobile metal balls, a hook, and a weighted head. The pair of mobile metal balls is rotatably positioned within an elongated hollow portion of the plastic rattle case by the stationary metal ball. The hook is passed through the weighted head such that the hook is adjacently and externally positioned with the elongated hollow portion. The plastic rattle case is secured to the hook by the weighted head, wherein the weighted head partially encloses the plastic rattle case and the hook. The metal to metal impact from the stationary metal ball and the pair of mobile metal balls create a sound and vibration that subsequently emit through the hook to attract fish when submerged and pulled underwater.

The current application claims a priority to the U.S. Provisional Patent application Ser. No. 62/069,423 filed on Oct. 28, 2014.

### FIELD OF THE INVENTION

The present invention relates generally to a fresh water and salt water fishing lure. More specifically, the present invention is a rattling lead-head jig that incorporates a durable and an effective rattling chamber.

### BACKGROUND OF THE INVENTION

Lead-head jigs that utilize a hook and a weighted head are commonly used for both fresh water and salt water fishing. The weight head defines different weight categories of the lead-head jig while the hook size also differs according to fishermen's preference. The lead-head jigs can be dressed with feathers, hair, soft plastic grubs, or with any selected the bait of choice. The lead-head jigs can also be combined with a rattle chamber to provide a resonating sound element so that fish can be easily lured. However, the existing rattle chambers in the fishing industry are made with soft lead material or glass material that limits the efficiency of the rattle chambers. For example, when the soft lead material is utilized to manufacture the rattle chamber, the effectiveness of the rattle chamber is weaken due to the fact that the soft lead material is a poor conductor of vibrations. When glass material is utilized to manufacture the rattle chamber, the glass material maximize the effectiveness of the rattle chamber; however, the reliability of the rattle chamber is compromised as the glass can break overtime.

It is an objective of the present invention to provide a lead-head jig apparatus that includes an improved and durable rattle chamber. More specifically, the present invention utilizes a plastic rattle chamber which resonates sound through the hook. The plastic rattle chamber provides more dependable rattle housing compare to glass, metal or quartz while improving the discharged resonating sound of the present invention.

### BRIEF DESCRIPTION OF THE DRAWINGS

FIG. 1 is a perspective view of the present invention.

FIG. 2 is a side view of the present invention, wherein the dash lines illustrate the inner components of the present invention.

FIG. 3 is a front view of the present invention, showing the plane upon which a cross sectional view is taken shown in FIG. 4.

FIG. 4 is a cross section view of the present invention taken along line A-A of FIG. 3.

FIG. 5 is a side view of the plastic rattle case of the present invention showing the opening, wherein the dashed lines illustrate the inner components of the plastic rattle case.

FIG. 6 is a side view of the plastic rattle case of the present invention showing the stationary metal ball, wherein the dashed lines illustrate the inner components of the plastic rattle case.

FIG. 7 is a side view of the present invention showing the additional flexible vinyl coating, wherein the dashed lines illustrate the inner components of the present invention.

### DETAIL DESCRIPTIONS OF THE INVENTION

All illustrations of the drawings are for the purpose of describing selected versions of the present invention and are not intended to limit the scope of the present invention.

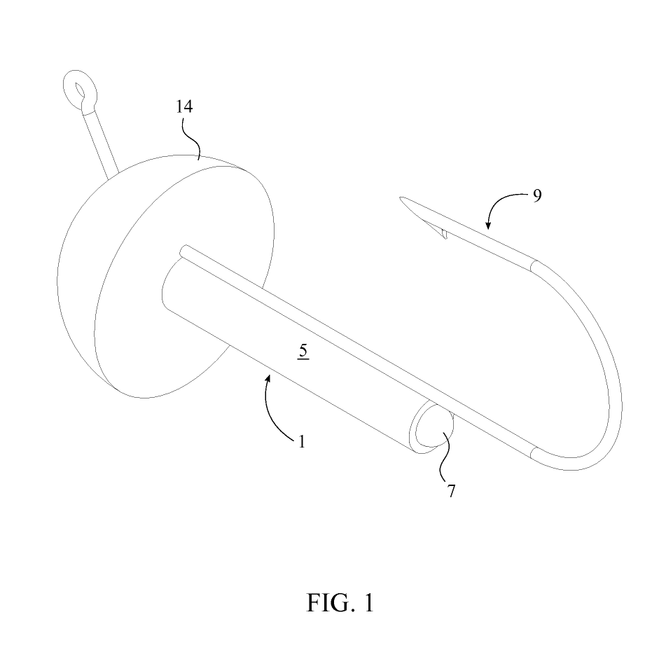

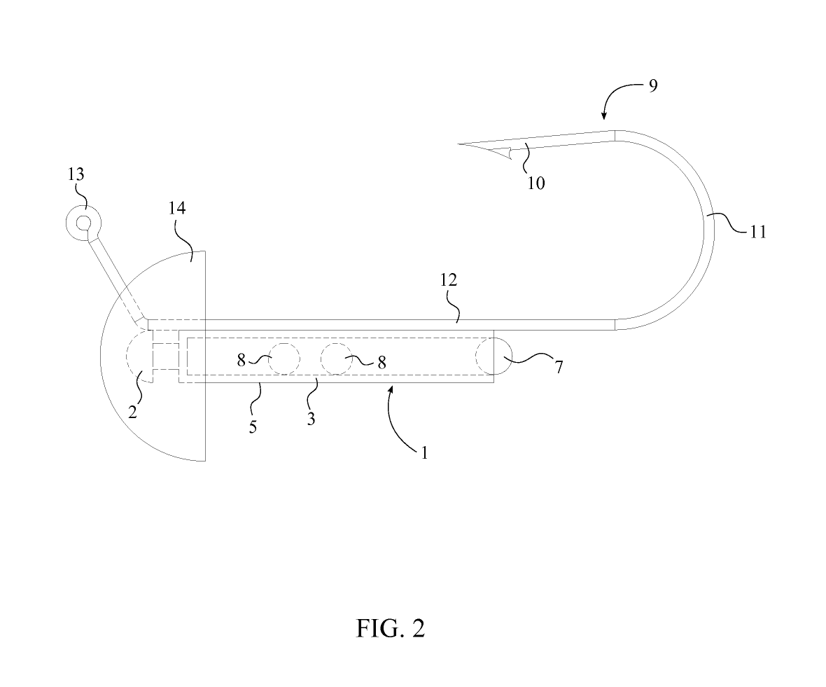

The present invention generally relates to a lead-head jig having a hard plastic rattle. More specifically, the present invention comprises a plastic rattle case 1, a stationary metal ball 7, a pair of mobile metal balls 8, a hook 9, and a weighted head 14. In the reference to the general configuration of the present invention that is shown in FIG. 1 and FIG. 2, the pair of mobile metal balls 8 is rotatably positioned within an elongated hollow portion 3 of the plastic rattle case 1 by the stationary metal ball 7. The hook 9 is passed through the weighted head 14 such that the hook 9 is adjacently and externally positioned with the elongated hollow portion 3. The plastic rattle case 1 is secured to the hook 9 by the weighted head 14 in a cantilevered orientation, wherein the weighted head 14 partially encloses the plastic rattle case 1 and the hook 9 from opposite of the stationary metal ball 7.

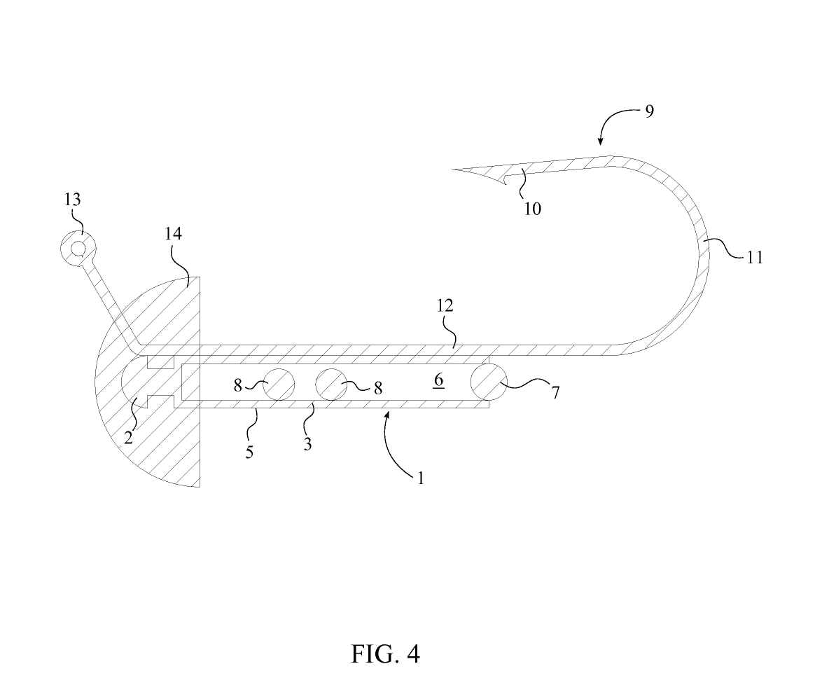

The plastic rattle case 1 is fabricated from hard plastic, which may be a cylindrical or other shaped tube having at least one closed end to retain the pair of mobile metal balls 8. In reference to FIG. 1 and FIG. 4, the plastic rattle case 1 comprises a head portion 2, an opening 4, an outer surface 5, and an inner surface 6 in addition to the elongated hollow portion 3. The head portion 2 is concentrically connected with the elongated hollow portion 3. More specifically, the head portion 2 firmly secures the plastic rattle case 1 to the weighted head 14 so that the plastic rattle case 1 does not separate from the weighted head 14 and the hook 9 when the present invention is utilized. The opening 4 is concentrically positioned on the elongated hollow portion 3 and positioned opposite of the head portion 2 along the elongated hollow portion 3. The opening 4 allows the pair of mobile metal balls 8 to be inserted into the elongated hollow portion 3 during the manufacturing process. The inner surface 6 is delineated within the elongated hollow portion 3 while the outer surface 5 is delineated around the elongated hollow portion 3 and the head portion 2. The opening 4 also allows the stationary metal ball 7 to be connected with the plastic rattle case 1 so that the pair of mobile metal balls 8 can be rotatably retained within the elongated hollow portion 3.

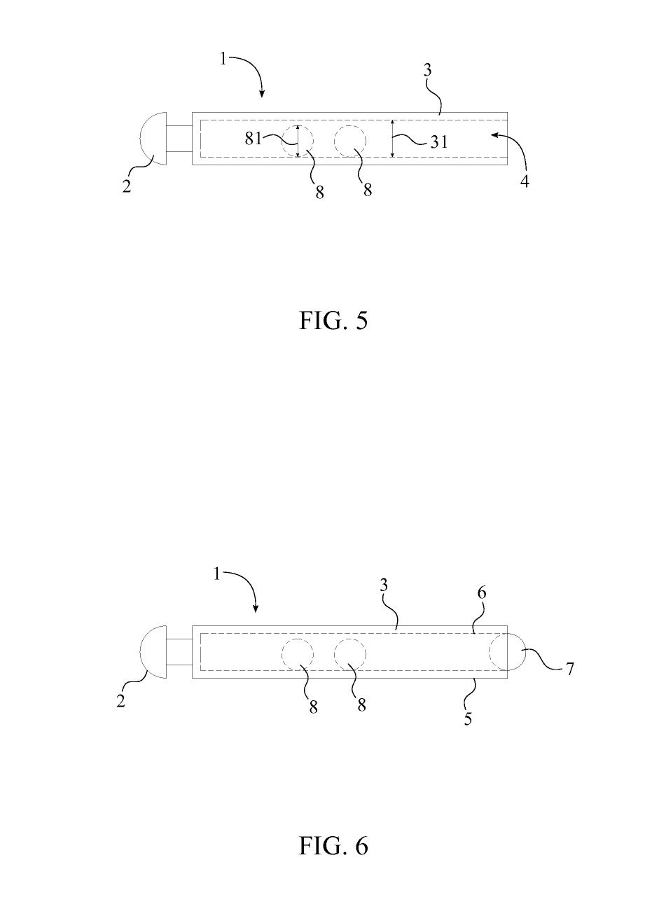

In reference to FIG. 5 and FIG. 6, when the pair of mobile metal balls 8 is inserted into the elongated hollow portion 3, the pair of mobile metal balls 8 is adjacently positioned with the inner surface 6. Additionally, an inner diameter 31 of the elongated hollow portion 3 is larger than a diameter 81 of the each mobile metal ball so that the pair of mobile metal balls 8 can be freely rotate and thus translate along the length of the elongated hollow portion 3 and along the inner surface 6. The stationary metal ball 7 is concentrically and adjacently positioned with the opening 4. Additionally, the stationary metal ball 7 is adjacently connected with the inner surface 6 to rotatably secure the pair of mobile metal balls 8 within the elongated hollow portion 3. The stationary metal ball 7 also hermetically seals the opening 4. As a result, the pair of mobile metal balls 8 and the inner surface 6 can be protected against unnecessary environmental elements such as water and dirt which would otherwise restrict their movement. When the stationary metal ball 7 is struck by the adjacent mobile metal ball, the metal to metal impact creates a metal sound that is louder than metal to glass. Same metal to metal impact is also achieved by the pair of mobile metal balls 8 when each mobile metal ball is struck together. Resulting metal to metal rattling sound greatly contributes to the sounds and vibration resonating from the hook 9 when the present invention is utilized by the users.

The hook 9 is a style suitable for fabrication of the present invention and can be manufactured from stainless or carbon steel. In reference to FIG. 2, the hook 9 comprises a barbed end 10, a bend 11, a shank 12, and an eye 13. The eye 13 may be offset to accommodate different styles of weighted head 14. The style of the hook 9 is generally selected such that the length of the shank 12 is equal or greater than the length of the plastic rattle case 1. In reference to the general configuration of the hook 9, the barbed end 10 is adjacently connected to the bend 11. The shank 12 is adjacently connected to the bend 11, but oppositely positioned from the barbed end 10 along the bend 11. The eye 13 is adjacently connected to the shank 12 and oppositely positioned of the bend 11 along the shank 12. When the hook 9 is secured to the plastic rattle case 1 by the weighted head 14, the shank 12 is positioned parallel with the elongated hollow portion 3. The shank 12 is also adjacently oriented along the outer surface 5 of the elongated hollow portion 3. As a result, the vibration resonating from the plastic rattle case 1 is seamlessly transferred into the hook 9 so that the hook 9 can emit the sound and vibration to attract fish.

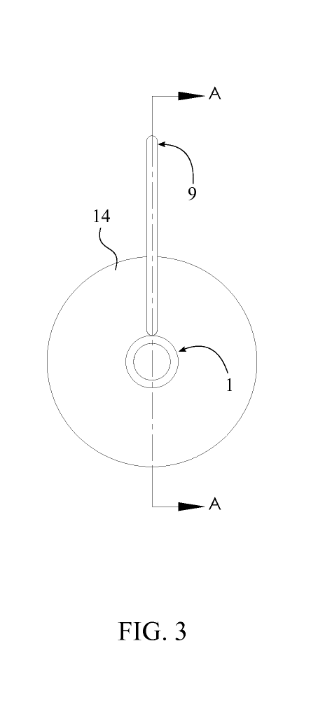

In reference to FIG. 3 and FIG. 4, the weighted head 14 may be a variety of shapes, such as round, oval, fish head, or other desirable geometric form suitable for fishing. The weighted head 14 provides weight to the present invention and encapsulates the plastic rattle case 1 and the hook 9. In reference to the plastic rattle case 1, the head portion 2 is fully enclosed by the weighted head 14 and the elongated hollow portion 3 is partially enclosed by the weighted head 14, adjacent to the head portion 2. In reference to the hook 9, the shank 12 is partially enclosed by the weighted head 14 such that the eye 13 is positioned adjacent to the weighted head 14. The weighted head 14 is preferably manufactured with a lead composition that comprises about five percent antimony and two percent tin. The antimony and tin content of the lead composition causes the weighted head 14 to shrink during cooling, thereby firmly securing the plastic rattle case 1 to the weighted head 14.

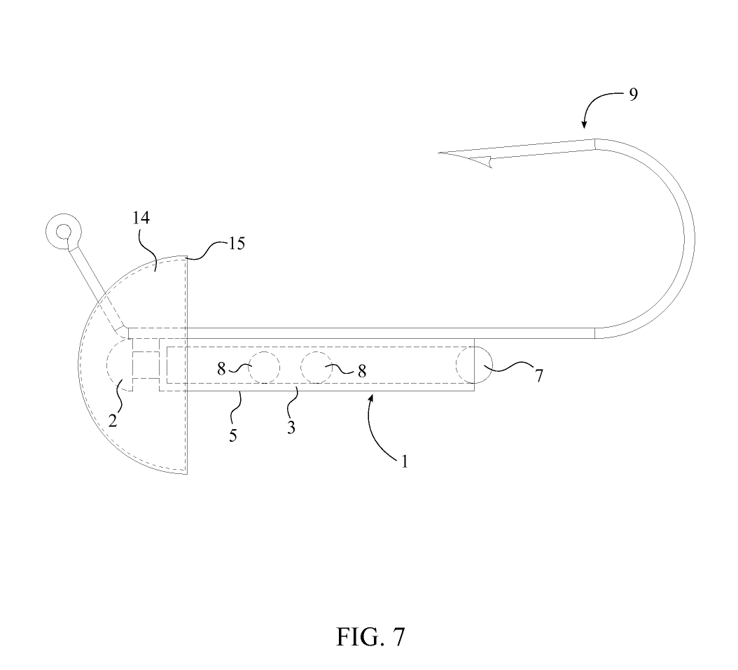

In reference to FIG. 7, the weighted head 14 may additionally comprise a flexible vinyl coating 15. The flexible vinyl coating 15 fully encloses the weighted head 14 and protects the weighted head 14 from unnecessary environmental elements. The flexible vinyl coating 15 also increases the strength of the weighted head 14. The plastic rattle case 1 does not require any type of plastic coating as the plastic rattle case 1 is substantially stronger than existing glass, brass or quartz rattle chambers. Accordingly, the present invention utilizing the plastic rattle case 1 is an improved version of the rattling or resonating lead-head jigs, due to the dependability of the plastic rattle case 1 as opposed to a glass, metal, or quartz rattle chambers. For example, the glass and quartz rattle chambers have a tendency to crack and the metal rattle chamber has a tendency to corrode and leak. However, the plastic rattle case 1 of the present invention continues to perform as intended under harsher conditions and for a longer period of time because it does not have a tendency to crack, corrode or leak.

Since only the head portion 2 and a section of the elongated hollow portion 3 are encased by the weighted head 14 and the majority of the elongated hollow portion 3 is free of the lead composition or flexible vinyl coating 15, the present invention is allowed to vibrate and project sound efficiently through the pair of mobile metal balls 8 and the stationary metal ball 7.

Although the invention has been explained in relation to its preferred embodiment, it is to be understood that many other possible modifications and variations can be made without departing from the spirit and scope of the invention as hereinafter claimed.

What is claimed is:

1. A rattling swimbait jig head comprises:
a plastic rattle case;
a stationary metal ball;
a pair of mobile metal balls;
a hook;
a weighted head;
the plastic rattle case comprises a head portion, an elongated hollow portion, an opening, an outer surface, and an inner surface;
the pair of mobile metal balls being rotatably positioned within the elongated hollow portion by the stationary metal ball;
the hook being adjacently and externally positioned against the elongated hollow portion; and
the plastic rattle case and the hook being partially enclosed by the weighted head, opposite of the stationary metal ball.

2. The rattling swimbait jig head as claimed in claim 1 comprises:
the head portion being concentrically connected with the elongated hollow portion;
the opening being concentrically positioned on the elongated hollow portion, opposite of the head portion;
the outer surface being delineated around the elongated hollow portion and the head portion; and
the inner surface being delineated within the elongated hollow portion.

3. The rattling swimbait jig head as claimed in claim 1 comprises:
the pair of mobile metal balls being adjacently positioned with the inner surface;
the stationary metal ball being concentrically and adjacently positioned with the opening; and
the stationary metal ball being adjacently connected with the inner surface.

4. The rattling swimbait jig head as claimed in claim 1, wherein an inner diameter of the elongated hollow portion being larger than a diameter of each mobile metal ball.

5. The rattling swimbait jig head as claimed in claim 1 comprises:
the hook comprises a barbed end, a bend, a shank, and an eye;
the barbed end being adjacently connected to the bend;
the shank being adjacently connected to the bend, opposite of the barbed end; and
the eye being adjacently connected to the shank, opposite of the bend.

6. The rattling swimbait jig head as claimed in claim 1 comprises:
a shank of the hook being oriented parallel with the elongated hollow portion; and
the shank being adjacently positioned along the outer surface of the elongated hollow portion.

7. The rattling swimbait jig head as claimed in claim 1 comprises:
the head portion being fully enclosed by the weighted head;
the elongated hollow portion being partially enclosed by the weighted head, adjacent to the head portion; and
a shank of the hook being partially enclosed by the weighted head, adjacent to an eye of the hook.

8. A rattling swimbait jig head comprises:
a plastic rattle case;
a stationary metal ball;
a pair of mobile metal balls;
a hook;
a weighted head;
the plastic rattle case comprises a head portion, an elongated hollow portion, an opening, an outer surface, and an inner surface;
the outer surface being delineated around the elongated hollow portion and the head portion;
the inner surface being delineated within the elongated hollow portion;
the pair of mobile metal balls being adjacently positioned with the inner surface;
the stationary metal ball being concentrically and adjacently positioned with the opening;
the stationary metal ball being adjacently connected with the inner surface;
the hook being adjacently and externally positioned against the elongated hollow portion; and
the plastic rattle case and the hook being partially enclosed by the weighted head, opposite of the stationary metal ball.

9. The rattling swimbait jig head as claimed in claim 8 comprises:
the head portion being concentrically connected with the elongated hollow portion; and
the opening being concentrically positioned on the elongated hollow portion, opposite of the head portion.

10. The rattling swimbait jig head as claimed in claim 8, wherein an inner diameter of the elongated hollow portion being larger than a diameter of each mobile metal ball.

11. The rattling swimbait jig head as claimed in claim 8 comprises:
the hook comprises a barbed end, a bend, a shank, and an eye;
the barbed end being adjacently connected to the bend;
the shank being adjacently connected to the bend, opposite of the barbed end; and
the eye being adjacently connected to the shank, opposite of the bend.

12. The rattling swimbait jig head as claimed in claim 8 comprises:
a shank of the hook being oriented parallel with the elongated hollow portion; and
the shank being adjacently positioned along the outer surface of the elongated hollow portion.

13. The rattling swimbait jig head as claimed in claim 8 comprises:
the head portion being fully enclosed by the weighted head;
the elongated hollow portion being partially enclosed by the weighted head, adjacent to the head portion; and
a shank of the hook being partially enclosed by the weighted head, adjacent to an eye of the hook.

14. A rattling swimbait jig head comprises:
a plastic rattle case;
a stationary metal ball;
a pair of mobile metal balls;
a hook;
a weighted head;
the plastic rattle case comprises a head portion, an elongated hollow portion, an opening, an outer surface, and an inner surface;
the head portion being concentrically connected with the elongated hollow portion;
the opening being concentrically positioned on the elongated hollow portion, opposite of the head portion;
the outer surface being delineated around the elongated hollow portion and the head portion;
the inner surface being delineated within the elongated hollow portion;
the pair of mobile metal balls being adjacently positioned with the inner surface;
the stationary metal ball being concentrically and adjacently positioned with the opening;
the stationary metal ball being adjacently connected with the inner surface;
an inner diameter of the elongated hollow portion being larger than a diameter of each mobile metal ball;
the hook being adjacently and externally positioned against the elongated hollow portion; and
the plastic rattle case and the hook being partially enclosed by the weighted head, opposite of the stationary metal ball.

15. The rattling swimbait jig head as claimed in claim 14 comprises:
the hook comprises a barbed end, a bend, a shank, and an eye;
the barbed end being adjacently connected to the bend;
the shank being adjacently connected to the bend, opposite of the barbed end; and
the eye being adjacently connected to the shank, opposite of the bend.

16. The rattling swimbait jig head as claimed in claim 14 comprises:
a shank of the hook being oriented parallel with the elongated hollow portion; and
the shank being adjacently positioned along the outer surface of the elongated hollow portion.

17. The rattling swimbait jig head as claimed in claim 14 comprises:
the head portion being fully enclosed by the weighted head;
the elongated hollow portion being partially enclosed by the weighted head, adjacent to the head portion; and
a shank of the hook being partially enclosed by the weighted head, adjacent to an eye of the hook.
